(19) United States
(12) Patent Application Publication
(10) Pub. No.: US 2022/0231568 A1
(43) Pub. Date: Jul. 21, 2022

(54) STATOR OF AN ELECTRIC MOTOR

(71) Applicant: Brose Fahrzeugteile SE & Co. Kommanditgesellschaft, Würzburg, Wuerzburg (DE)

(72) Inventors: Moritz OBENDORFER, Wuerzburg (DE); Keshar SHENDARE, Pune (IN); Alexander VOLKAMER, Oberscheinfeld (DE)

(21) Appl. No.: 17/609,465

(22) PCT Filed: May 5, 2020
(86) PCT No.: PCT/EP2020/062422

§ 371 Date: Mar. 4, 2022

(30) Foreign Application Priority Data
May 8, 2019 (DE) 10 2019 206 641.0

(51) Int. Cl. H02K 5/22; H02K 1/16; H02K 3/28; H02K 3/50

(52) U.S. Cl. CPC H02K 5/225; H02K 3/505; H02K 3/28; H02K 1/16

(57) ABSTRACT

A stator of an electric motor has stator teeth that carry coils of a multi-phase stator winding. A connection element has insert pockets with contact elements inserted therein each with at least one insulation displacement contact as a connection point for a wire portion of coils joined to one another. A contact apparatus is mounted on the connection element and has a contact housing with a connection socket with phase plug connectors corresponding to the number of phases. The contact apparatus has busbars which correspond to the number of phases and which each have a first and a second bar end. The first bar ends are flexibly or movably in contact with one of the phase plug connectors each and the second bar ends are each inserted or can each be inserted in a contact slot of one of the contact elements to form a terminal connection.

The invention relates to a stator of an electric motor, having a number of stator teeth, which carry coils of a multi-phase stator winding, and an interconnection element having a number of insert pockets with contact elements inserted therein, each with at least one insulation displacement contact as an interconnection point for a wire portion of coils connected to one another. The invention further relates to an electric motor comprising such a stator, and to a contact device for such a stator.

Nowadays, many motor vehicles have an anti-lock braking system (ABS) as an integrated auxiliary system which increases driving safety and reduces wear on the tread surfaces of the vehicle tires. When the motor vehicle brakes, the ABS repeatedly reduces and increases the braking pressure (pressure modulation) to counteract a possible locking of the vehicle wheels. This significantly improves the steerability and directional stability of the motor vehicle during a braking operation. Particularly on wet or damp road surfaces, the braking distance of the motor vehicle is also reduced by means of the ABS.

As a rule, such ABS have a wheel speed sensor for each vehicle wheel to determine the current wheel speed and a controller (control unit) to evaluate the sensor signals. The braking force for each individual vehicle wheel is controlled here in an open-loop and/or closed-loop fashion as a function of the evaluated signals. For this purpose, the controller is coupled to a brake motor for actuating the wheel brakes.

Such brake motors are increasingly being designed as so-called brushless electric motors (brushless DC motor, BLDC motor), in which the wear-prone brush elements of a rigid (mechanical) commutator are replaced by an electronic commutation of the motor current.

A brushless electric motor as an electric (three-phase) machine has a stator with a stator laminated core with a number of stator teeth arranged, for example, in a star shape, which carry an electric rotating field winding or stator winding in the form of individual stator coils, which in turn are wound from an insulating wire. The coils are assigned to individual strands or phases of the machine and are interconnected in a predetermined manner.

In a three-phase electric motor, the stator has a stator winding with three phases, and thus, for example, three phase conductors or phase windings, each of which is energized in a phase-shifted manner with electric current to generate a magnetic rotating field in which a rotor or armature, usually provided with permanent magnets, rotates. The phase ends of the phase windings are fed to motor electronics to control the electric motor. The coils of the rotating field winding are interconnected in a specific way, for example, by means of an interconnection element mounted on the end face of the stator. The type of interconnection is determined by the winding pattern of the rotating field winding, wherein a star connection or a delta connection of the phase windings is usual as a winding pattern.

For interconnection, the wire portion of the winding wire to be contacted is pressed, for example, into a sleeve-like insert pocket of the interconnection element and mechanically fixed inside the insert pocket with a metallic insulation displacement contact (clamping connector) that can be inserted into the insert pocket. The insulation displacement contact typically has at least one cutting edge which, when inserted into the insert pocket, cuts through the insulation of the insulating wire of the coil winding in such a way that, when the insulation displacement contact is inserted, one core of the winding wire is electrically conductively coupled to the insulation displacement contact.

In the assembled state, the insulation displacement contacts are contacted via phase connections of the electric motor or the stator to the motor electronics for energizing the phases. For simple and flexible integration of the stator and/or the electric motor in different applications, for example in different ABS, it is necessary that the phase connections are coupled or can be coupled to a corresponding customer-specific or application-specific connection.

A stator of an electric motor with an annular interconnection element is known from DE 10 2015 200 093 A1. The phase connections of the interconnection element are embodied here as insulation displacement contacts and each have a contact slot at a free axial end, into which contact slot a wire or a clamping element of a corresponding connector of a customer can be inserted. The axially oriented phase connections are each supported by two retaining walls of an associated retaining receptacle or insert pocket, so that the phase connections do not bend over or buckle when the customer connector is inserted.

The invention addresses the problem of specifying a particularly suitable stator for an electric motor. In particular, a particularly simple and flexible contacting of a customer-specific power source or a customer-specific connector with the interconnection points of the stator winding is to be realized. The invention also addresses the problem of specifying a particularly suitable electric motor comprising such a stator, as well as a contact device for such a stator.

With regard to the stator, the problem is solved in accordance with the invention by the features of claim 1 and with regard to the electric motor by the features of claim 9 and with regard to the contact device by the features of claim 10. Advantageous embodiments and refinements are the subject of the dependent claims. The advantages and embodiments described in respect of the stator can also be applied similarly to the electric motor and/or the contact device, and vice versa.

The stator according to the invention is suitable and designed for an electric motor, in particular a brushless electric motor. The stator has, for example, a stator laminated core with a number of stator teeth arranged, for example, in a star shape. The stator teeth carry a multiphase stator winding or rotating field winding. This means that the stator teeth are wound around with a winding wire or coil wire. The stator winding is preferably in the form of a plurality of coils, wherein the coils are suitably phase-selectively interconnected to form phase strands.

The stator further has an interconnection element, for example in the form of a disc or (circular) ring, which is placed in particular on the pole shoe side on one end face of the stator laminated core. The interconnection element is embodied with a number of insert pockets with contact elements inserted or pressed into them. The insert pockets are formed integrally here, for example, in one piece, i.e., in one part or monolithically, on the interconnection element. The insert pockets each have, for example, a tangentially directed insert slot in which contact elements with at least one insulation displacement contact are inserted as an interconnection point for a wire portion of interconnected coils.

The stator further has a contact device fitted on the interconnection element at least in part. The contact device is designed, for example, in the form of a circle or (circular) ring sector and has a contact housing (contact carrier) with a connection socket or connection box, in particular formed integrally in one piece thereon, with a number of phase connectors corresponding to the number of phases.

The contact device has a number of busbars corresponding to the number of phases, each busbar having a first bar end and a second bar end. The first bar ends are flexibly or movably contacted to one each of the phase connectors, wherein the second bar ends are inserted or insertable in one contact slot (clamping slot, contact gap) each of one of the contact elements with clamping contact. In other words, the second bar ends engage in contacting manner, for example in the manner of a knife contact, in the contact slot of the assigned contact element. The contact slots of the contact elements thus serve to receive at least a portion of the second bar ends. In this way, a particularly advantageous stator of an electric motor is realized.

In this case, the contact device is embodied or can be embodied in particular as a customer-specific interface of the stator or of the electric motor. This enables particularly simple and flexible contacting of the stator with a customer-specific power source or with a customer-specific connector.

The additional contact device can be used, for example, to compensate for position tolerances of the customer interface to a controller or an electronic control unit (ECU) of an associated motor electronics system.

Furthermore, the contact device can be assembled substantially independently of the interconnection element. This means that when the stator or the electric motor is assembled, the assembly or interconnection of the stator winding with the interconnection element and with the contact device is performed in separate or distinct assembly steps. In other words, the stator winding supported by the stator teeth is pre-assembled and provided by means of the interconnection element, in particular phase-selectively interconnected so as to form phase strands. Subsequently, a corresponding contact device can be fitted, taking into account the requirements of a particular desired application.

As a result, the stator according to the invention exhibits a particularly high degree of flexibility with regard to a customer interface, without the need for any changes to the wound stator core or the interconnection element.

The busbars advantageously reduce the amount of wiring required when assembling the contact device. Due to the flexible or movable contacting between the first bar ends and the phase connectors, a particularly durable and stable electrical connection is realized, which is suitable and designed in particular with regard to vibrations of the electric motor and/or the stator that occur during operation.

The term “axially” or an “axial direction” is understood here and in the following to mean in particular a direction parallel (coaxial) to the axis of rotation of the electric motor, i.e., perpendicular to the end faces of the stator. Accordingly, “radial” or a “radial direction” is understood here and in the following to mean in particular a direction oriented perpendicular (transverse) to the axis of rotation of the electric motor along a radius of the stator or of the electric motor. The term “tangential” or a “tangential direction” is understood here and in the following to mean in particular a direction along the circumference of the stator or the electric motor (circumferential direction, azimuthal direction), i.e., a direction perpendicular to the axial direction and the radial direction.

In an advantageous embodiment, the contact housing has a number of radially directed recesses on its outer circumference, each of which exposes one of the second bar ends. In other words, the second bar ends are exposed by the recesses. Thus, the contact slots of the contact elements of the interconnection element are also at least partially accessible when the contact device is fitted. The recesses are thus embodied substantially as windows of the contact housing. During the course of assembly, it is thus possible to engage a press-in tool with which the second bar ends can be pressed reliably into their respective contact slots of the associated contact elements. The press-in tool engages here in the particular recess as access, in order to press the corresponding second bar end into the associated contact slot. This ensures particularly simple and reliable assembly and press-fit or clamping contacting of the contact device and thus of the stator. In particular, the stator can thus be flexibly adapted to different customer interfaces with particular ease.

In a suitable refinement, the first bar ends are each contacted with a flexible conductor, for example by means of a stranded wire, at the phase connectors. This provides a particularly simple and cost-effective electrical connection between the busbars and the phase connectors.

In an alternative, equally suitable refinement, the phase connectors each have a flexurally elastic contact lug in the form of a spring hook or spring tab, against which the first bar ends bear resiliently to establish contact. This means that the contact lug is designed as a flexible spring leg which is guided under a certain pretension to the comparatively rigid or fixed first bar end. Due to the mechanical pretension, at least a certain restoring force always acts here, which forces the contact lug into a position bearing against the first bar end—and thus electrically conductive. The electrical connection is thus realized substantially by a floating mounting of the electrical contacts (contact lug, bar end) by means of an elastic bending. This provides a reliable and safe electrical connection.

The busbars are preferably fastened to or in the contact housing in an integrally bonded and/or form-fitting and/or frictionally engaged manner. The conjunction “and/or” is to be understood here and in the following in such a way that the features linked by means of this conjunction can be provided both together and as alternatives to one another.

An “integral bond” or an “integrally bonded connection” between at least two interconnected parts is understood here and in the following in particular to mean that the interconnected parts are held together at their contact faces by a material combination or crosslinking (for example due to atomic or molecular bonding forces), possibly under the action of an additive.

A “form fit” or a “form-fitting connection” between at least two interconnected parts is understood here and in the following to mean in particular that the interconnected parts are held together at least in one direction by direct interlocking of contours of the parts themselves or by indirect interlocking via an additional connecting part. The “locking” of a reciprocal movement in this direction is thus achieved as a result of the shape.

A “frictional engagement” or a “frictionally engaged connection” between at least two interconnected parts is understood here and in the following to mean in particular that the interconnected parts are prevented from sliding against each other due to a frictional force acting between them. If a “connecting force” (i.e., the force which presses the parts against each other, for example a screw force or the weight force itself) causing this frictional force is missing, the frictionally engaged connection cannot be maintained correctly and can therefore be released.

In one possible embodiment, the busbars are embodied as insert parts, for example, and are overmolded by the contact housing. In other words, the contact housing is embodied substantially as an injection-molded part, wherein the busbars are embedded in the contact housing in a form-fitting and/or frictionally engaged manner. The contact housing is made here in particular from an electrically non-conductive plastic. This makes for a contact device that is of a particularly simple design and can be produced cost-effectively. This is advantageously transferred to the manufacturing costs of the stator.

In an alternative design, the contact housing has grooves or gaps in which the busbars are inserted. For example, the busbars are pressed into the grooves in a form-fitting and/or frictionally engaged manner. Alternatively, it is possible, for example, for the busbars to be glued into the grooves in an integrally bonded manner by means of an adhesive. It is also possible, for example, for the grooves to have protruding extensions in the region of their side walls, which extensions, after insertion of the busbars into the grooves, are deformed or re-shaped in such a way that the busbars are held in a form-fitting and/or frictionally engaged manner in the grooves. In particular, it is conceivable that the busbars are fixed in the grooves by means of hot caulking of the extensions.

In an expedient embodiment, the contact housing has, on an underside (inner side) facing the interconnection element, a number of axially projecting support surfaces as functional or contact surfaces for axial support of the contact device on the interconnection element. The support surfaces are suitable and designed for limiting the joining path when the contact device is fitted axially on the interconnection element. In other words, the support surfaces determine the (axial) end position of the contact device during assembly. The support surfaces are designed, for example, as locally reinforced material thicknesses or wall thicknesses of the contact housing, which take up the mechanical forces occurring during assembly. The support surfaces define the press-in depth of the relevant second bar ends in the contact slots of the contact elements in a targeted manner, wherein the support surfaces of the contact device are suitably supported on corresponding contours of the interconnection element. This ensures particularly simple and effort-reduced assembly of the stator.

In an advantageous refinement, the contact element has a second insulation displacement contact spaced apart from the insulation displacement contact. This means that the contact element has two insulation displacement contacts. These are suitably spaced apart from one another and expediently provided on the same side of the contact element. A second contact slot of the contact element is also suitably provided. The contact slots for the second bar ends, which are then provided on the opposite side of the contact element or can be accessed from there, are suitably axially aligned with the two insulation displacement contacts, but on the opposite side of the contact element in the axial direction. In this way, an expedient contact element of the stator is realized.

The electric motor according to the invention is suitable and set up in particular as a brushless brake motor for an anti-lock braking system of a motor vehicle. In this case, the electric motor has a pot-shaped motor housing as a pole pot, which is closed at the end face by an end shield, with a stator described above being inserted into the motor housing. The stator according to the invention provides a particularly suitable electric motor which can be adapted particularly easily and flexibly to a particular customer interface, especially with regard to different applications or customer requirements.

The electric motor is embodied, for example, as an internal rotor motor, in which a rotor fixed to a motor shaft rotates in the rotating field of an external, fixed stator (fixed to the housing). The motor shaft is rotatably mounted here, for example, by means of a rolling bearing of the end shield. At one shaft end of the motor shaft, for example, a magnetic encoder is provided as a rotary encoder or position encoder for the rotor and/or the electric motor. The end shield suitably has a feed-through opening, i.e., an aperture or a recess, for the connection socket of the contact device. This means that the connection socket extends through the end shield and projects axially beyond it at least in part. This makes it particularly easy to contact or connect the electric motor to a customer interface.

The contact device according to the invention is suitable and set up for a stator with a number of stator teeth, which carry phase-selectively connected coils of a multi-phase stator winding, and with an interconnection element with a number of insert pockets with contact elements inserted therein, each with at least one insulation displacement contact as an interconnection point for a wire portion of coils connected to one another.

In this case, the contact device has a contact housing with a connection socket with a number of phase connectors corresponding to the number of phases, which contact housing is fitted or can be fitted axially on the interconnection element. A number of busbars corresponding to the number of phases is provided, each with a first and a second bar end, wherein the first bar ends are flexibly or movably contacted to one of the phase connectors each, and wherein the second bar ends are inserted or can be inserted into a contact slot each of one of the contact elements, with clamped contact. This provides a particularly suitable contact device, in particular in the form of a configurable or exchangeable customer interface.

In the following, exemplary embodiments of the invention are explained in more detail with reference to a drawing, which show:

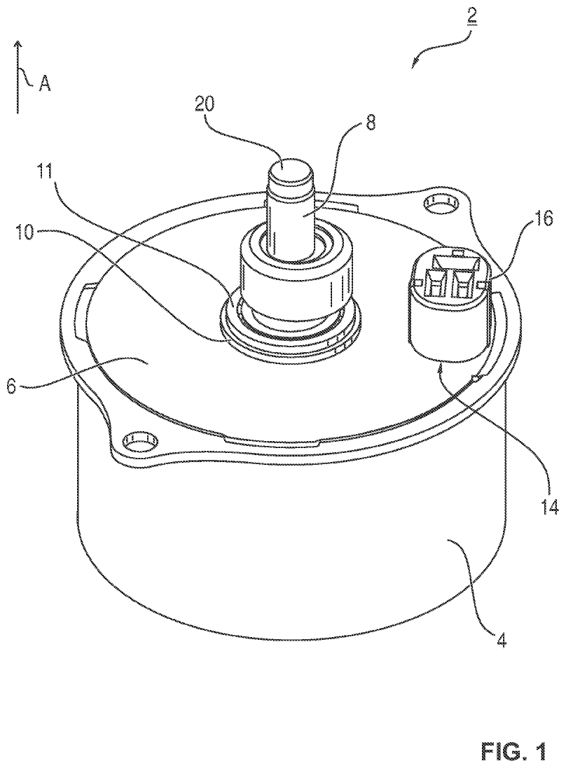

FIG. 1 in perspective view, an electric motor with a motor housing and with an end shield,

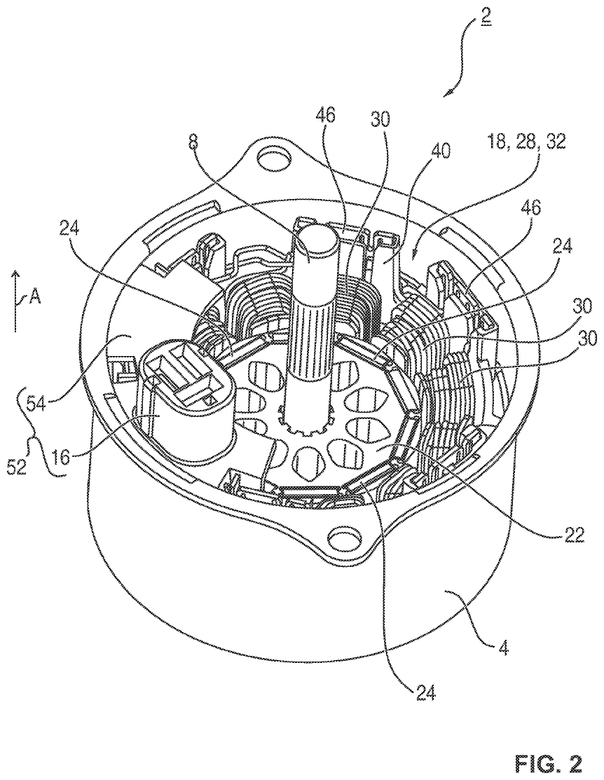

FIG. 2 in perspective view, the electric motor without end shield,

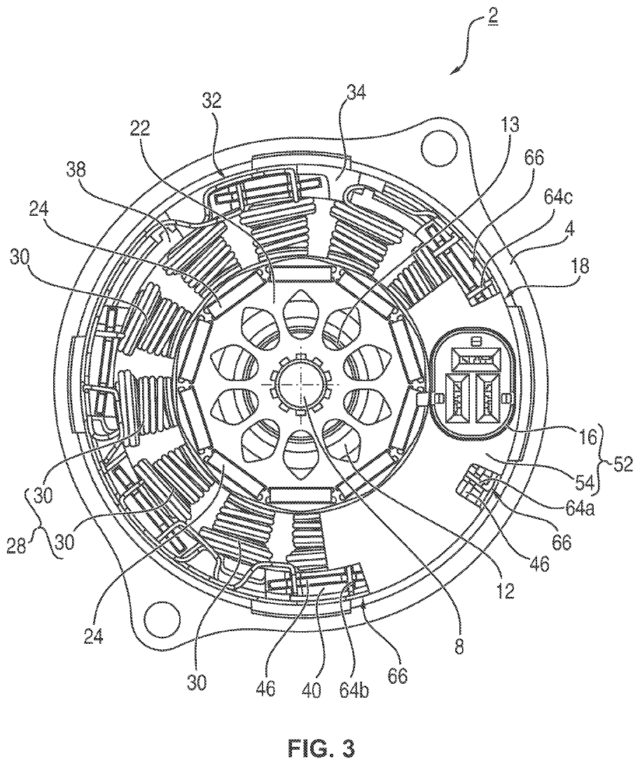

FIG. 3 in plan view, the electric motor according to FIG. 2,

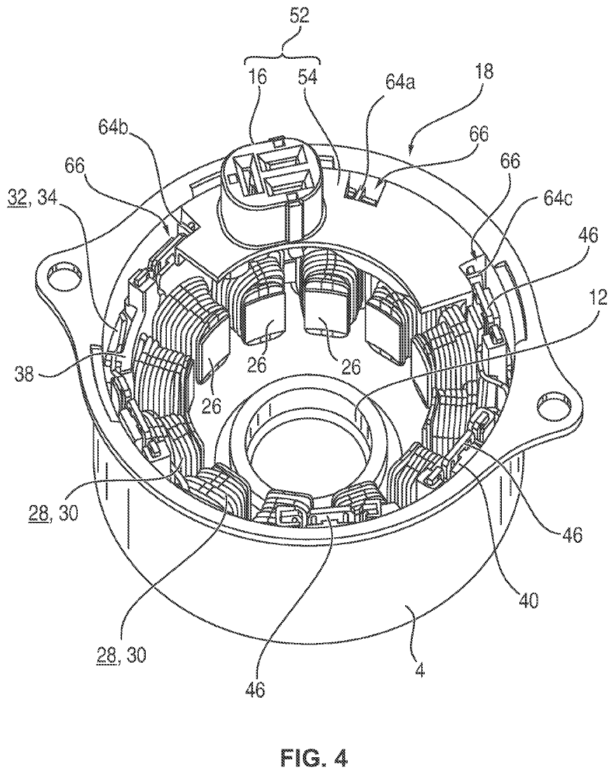

FIG. 4 in perspective view, a stator of the electric motor, with a stator winding and with an annular interconnection element and with a ring-sector-shaped contact device,

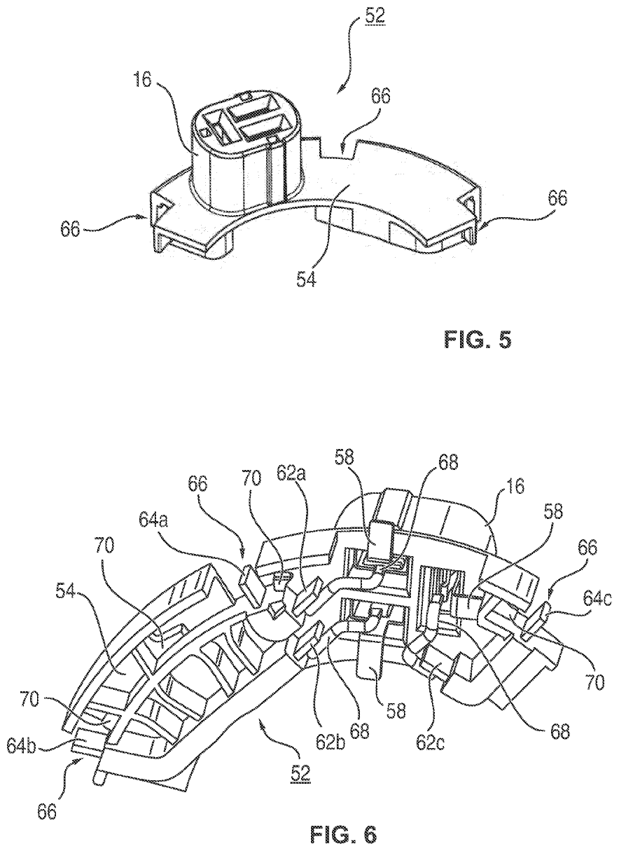

FIG. 5 in perspective view, a first exemplary embodiment of the contact device, looking at an upper side,

FIG. 6 in perspective view, the first exemplary embodiment of the contact device, looking at a bottom side,

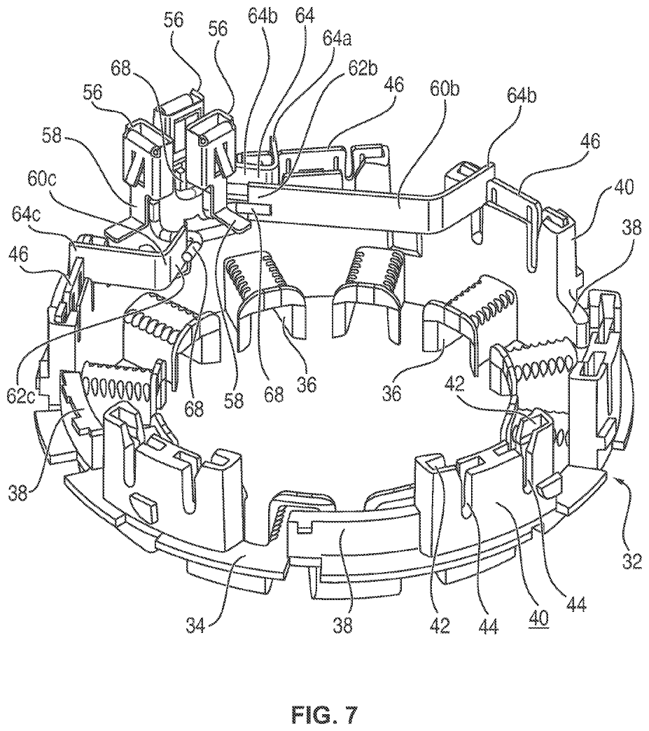

FIG. 7 in perspective view, a detail of the interconnection element and the first exemplary embodiment of the contact device in a partially disassembled state,

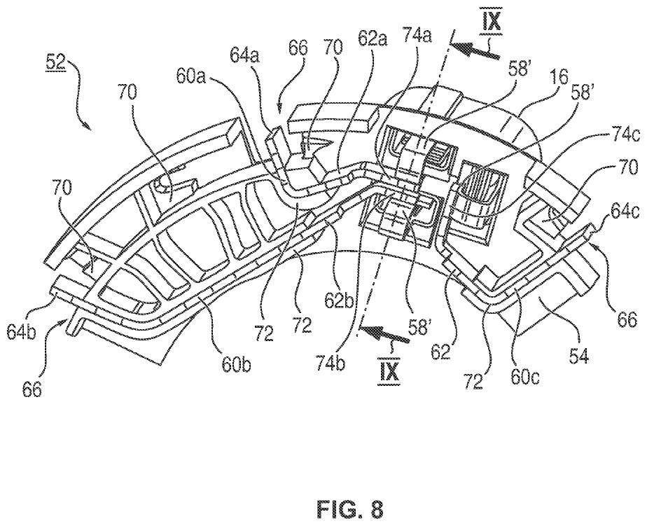

FIG. 8 in perspective view, a second exemplary embodiment of the contact device, looking at a bottom side,

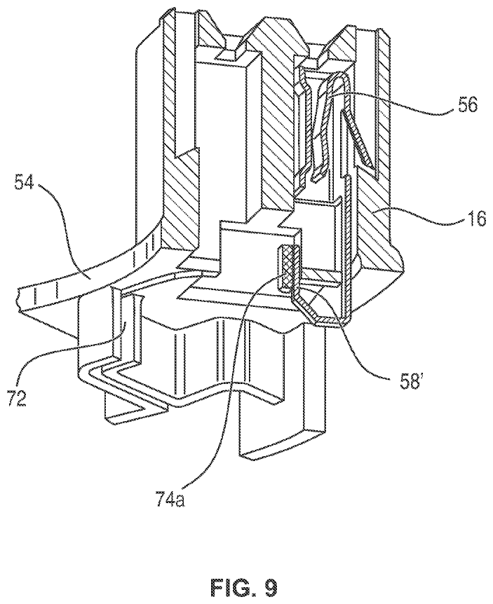

FIG. 9 a sectional view of the second exemplary embodiment of the contact device along the line of section IX-IX according to FIG. 8,

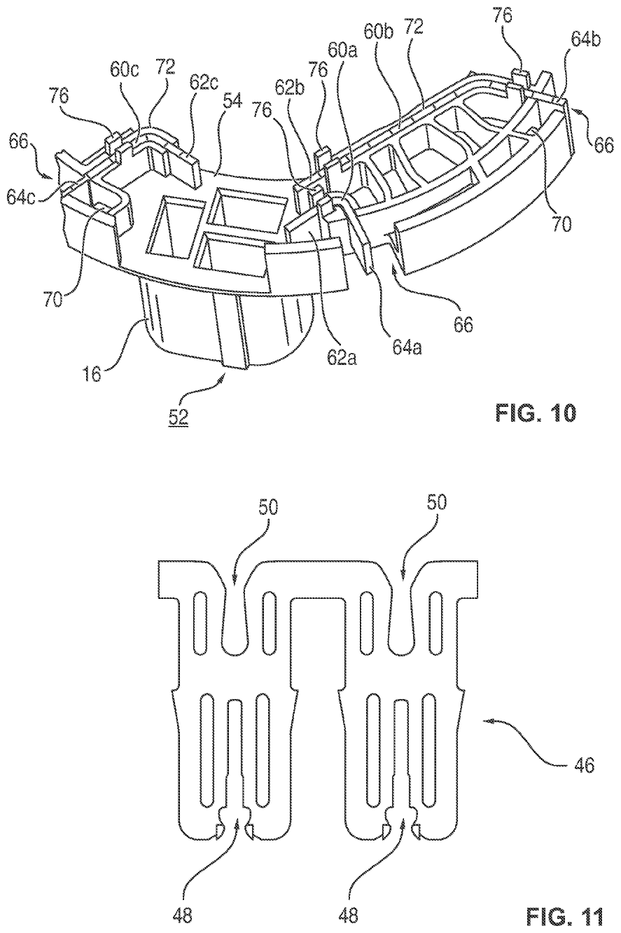

FIG. 10 in perspective view, a third exemplary embodiment of the contact device, looking at a bottom side, and

FIG. 11 in front view, a contact element of the interconnection element.

Corresponding parts and dimensions are always provided with the same reference signs in all figures.

FIGS. 1 to 4 show a brushless electric motor 2. The electric motor 2 is embodied, for example, as a brake motor for an anti-lock braking system (ABS) of a motor vehicle not shown in greater detail.

The electric motor 2 has a pole pot as motor housing 4, which is closed at the end face by means of an end shield 6. The end shield 6 has a central recess for a motor shaft (rotor shaft) 8. A bearing seat 10 for a rolling bearing 11 is suitably provided in the region of this recess. Opposite the bearing seat 10, a bearing seat 12 is formed in the bottom of the motor housing 4 (FIG. 3, FIG. 4), in which a second rolling bearing 13 (FIG. 3) is inserted. The motor shaft 8 is rotatably mounted about a motor axis by means of the rolling bearings 11, 13. The end shield 6 has a feed-through opening 14 radially on the outside, which is penetrated by a connection bushing 16 of a stator 18 (FIG. 2).

The motor shaft 8 has a magnetic encoder 20 fixed to the shaft end for conjoint rotation. The magnetic encoder 20 is designed, for example, as a magnetic dipole encoder in the form of a magnetic cap. In the installed state of the electric motor 2, the magnetic encoder 20 is expediently arranged in the vicinity of a magnetic sensor or Hall sensor so that, during operation of the electric motor 2, its motor speed and/or rotor position can be monitored by the alternating magnetic field of the rotating magnetic encoder 20.

As can be seen comparatively clearly in FIG. 2 and in FIG. 3, the electric motor 2 is embodied as an internal rotor motor with the stator 18 on the radially outer side and a rotor 22 joined fixedly to the motor shaft 8. In the assembled state, the rotor 22 is rotatably mounted inside the stationary stator 18 so as to be rotatable about the axis of rotation of the motor along an axial direction A. The rotor 22 is formed (in a manner not shown in greater detail) by a laminated core in which permanent magnets 24 are inserted to generate an excitation field. The permanent magnets 24 are provided with reference signs in the figures merely by way of example.

The stator 18 has a stator laminated core, not described in further detail, with a circumferential stator yoke, from which a number of stator teeth 26 (FIG. 4) extend radially inward. The stator laminated core is provided with a stator winding 28 for generating a magnetic rotating field.

In the exemplary embodiment shown, the stator 18 has a three-phase stator winding 28, which is wound in the form of (stator) coils 30 onto the stator teeth 26. The coils 30, which are provided with reference signs merely by way of example, are phase-selectively connected to one another to form phase strings or phase windings. In this embodiment, the stator laminated core has an approximately star-shaped arrangement with twelve inwardly directed stator teeth 26, wherein one phase winding per phase of the stator winding 28 is wound around two adjacent stator teeth 26 in each case and around the two stator teeth 26 arranged diametrically opposite hereto in the stator laminated core to form a magnetic pole.

An electric current flows through the three phase windings during operation of the electric motor 2 and thus forms six magnetic pole regions of the stator 18. For guiding, routing and interconnecting the phase windings on the stator teeth 26, the stator 18 has two routing or interconnection rings as interconnection elements 32. The interconnection elements 32 are each fitted axially here on one of the end faces of the stator laminated core. In the figures, only the interconnection element 32 facing the end shield 6 is shown and marked with a reference sign.

The annular interconnection elements 32, which are made from an insulating plastic material, each have an annular body 34, on which twelve half-sleeve-like coil formers 36 are integrally formed on the stator lamination side in the form of pole-shoe-like receptacles for the stator teeth 26 (FIG. 7). Once fitted in place, the stator teeth 26 are thus substantially surrounded by the insulating coil formers 36 of the interconnection elements 32 in such a way that only the pole-shoe-side ends of the stator teeth 26 are exposed (FIG. 4).

The coils 30 or phase windings are wound onto the coil formers 36 of the interconnection elements 32 around the stator teeth 26 with an insulated copper wire (coil wire, winding wire). In order to prevent the coils 30 from detaching from the coil formers 36 in the wound state, each coil former 36 has an inner flange on the radially inner side with respect to the stator laminated core and an outer flange offset radially outwardly with respect thereto as delimiting side walls.

The upper, i.e., end-shield-side, interconnection element 32 shown in the figures has a segmented, circular ring-like wall as termination 38. As can be seen in particular in FIG. 7, the termination 38 protrudes axially beyond the stator laminated core along the axial direction A in the assembled state. During the winding of the coils 30, the coil wires or winding wires are wound through the termination 38 circumferentially behind the stator teeth 26 to form the magnetic poles.

To form the phase strands or phase winding, the coils 30 are electrically interconnected at their coil ends and/or a wire portion (coil portion) arranged in between. For this purpose, the interconnection element 32 has six insert pockets 40 distributed around the circumference, which are integrally formed in one part, i.e., in one piece or monolithically, on the ring body 34. The insert pockets 40 are designed in particular as insert pocket pairs, which each have two tangentially running insert slots 42 open axially on one side. The insert pockets 40 each have two radially directed slots 44 through which the wire portions of the coils 30 are guided.

A metal contact element 46 is inserted or pressed as a clamping connector into each of the insert pockets 40. The contact element 46 shown individually in FIG. 11 has two insulation displacement contacts 48 as interconnection points for the coil portions seated in the slots 44. The contact element 46 is thus embodied as a pair of insulation displacement contacts or as a double insulation displacement contact plug (double IDC). In the assembled state, the insulation displacement contacts 48 are inserted into one each of the insert slots 42 of the insert pockets 40.

The insulation displacement contacts 48 are arranged at a distance from each other and are provided on the same side of the contact element 46. On the axially opposite side of the contact element 46, two clamping or contact slots 50 are provided, which are accessible from there and which are arranged axially in alignment with the insulation displacement contacts 48. In the clamped contacted state of the coils, the contact slots 50 are arranged at least in some portions radially aligned with the slots 44. The insert pockets 40 and the contact elements 46 are provided with reference signs in the figures merely by way of example.

As can be seen in FIGS. 1 to 4, in the assembled state of the stator 18 a contact device 52 is placed axially on the end-shield-side interconnection element 32. The contact device 52 is designed as a customer-specific interface of the stator 18 or the electric motor 2. The contact device 52 is explained in greater detail below, in particular with reference to FIGS. 5 to 10.

The contact device 52, which is shown individually in FIG. 5, for example, is of ring-sector-shaped design, and has a contact housing (contact carrier) 54 with the connection socket 16 formed integrally thereon, in particular in one piece. The ring-sector-shaped contact device 52 extends here, for example, over an angular range of about 120°. The connection box 16 here has three integrated phase connectors 56 for electrically conductive connection, i.e., for connection or contacting of the stator winding 28 (FIG. 7).

The phase connectors 56 are designed here as latchable or clippable plug receptacles or plug sockets for a customer-specific power source or for a customer-specific connector or plug. The phase connectors 56 furthermore each have a contact lug 58, and busbars 60a, 60b, 60c are guided one to each of said contact lugs and electrically conductively contact the latter.

The busbars 60a, 60b, 60c are each embodied as an approximately L-shaped stamped-and-bent part. The busbars 60a, 60b, 60c each have a first bar end 62a, 62b, 62c and a second bar end 64a, 64b, 64c, which substantially form the free ends of the corresponding L-leg. The bar ends 62a, 62b, 62c are here flexibly or movably contacted to the phase connector 56 or to the contact lug 58 thereof, wherein the bar ends 64a, 64b, 64c, which are in particular radially oriented or aligned, are each inserted or can be inserted with clamping contact into a contact slot 50 of one of the contact elements 46 (see for example FIG. 7).

The contact housing 54 has a number of radially directed and tangentially extending recesses 66 on its outer circumference. As can be seen, for example, from FIGS. 6, 8 and 10, the recesses 66 substantially expose the bar ends 64a, 64b, 64c. As can be seen in particular from FIGS. 2 to 4, the contact slots 50 of the contact elements 46 of the interconnection element 32 are also at least partially accessible through the recesses 66 when the contact device 52 is fitted in place. The recesses 66 are thus embodied as windows of the contact housing 54, which allow engagement of a press-in tool during the course of an assembly process.

In the following, a first exemplary embodiment of the contact device 52 is explained in greater detail with reference to FIG. 6 and FIG. 7.

In this embodiment, the busbars 60a, 60b, 60c are embodied as insert parts, and are overmolded by the material of the contact housing 54 in such a way that only the bar ends 62a, 62b, 62c and 64a, 64b, 64c are exposed. In this case, the contact housing 54 is made of an electrically non-conductive plastic.

In this exemplary embodiment, a flexible conductor 68 in the form of a stranded wire is arranged between the bar ends 62a, 62b, 62c and the associated contact lugs 58.

On an underside (inner side) facing the interconnection element 32, the contact housing 54 has four axially projecting support surfaces 70 as functional or contact surfaces for axial support of the contact device 52 on the interconnection element 32. The support surfaces 70 are distributed here along an arc in the region of the outer circumference of the contact housing 54.

The support surfaces 70 are suitable and designed for limiting the joining path when the contact device 52 is fitted axially on the interconnection element 32. The support surfaces 70 are embodied as locally reinforced material thicknesses or wall thicknesses of the contact housing 54. The support surfaces 70 specifically define the press-fit depth of the bar ends 64a, 64b, 64c into the contact slots 50 of the contact elements 46, wherein the support surfaces 70 of the contact device 52 are supported on corresponding contours of the interconnection element 32.

The second exemplary embodiment of the contact device 52 shown in FIG. 8 and in FIG. 9 differs from the embodiment described above basically in that the busbars 60a, 60b, 60c are not embodied as insert parts, and in that the contact lugs 58′ of the phase connectors 56 are bent axially (around).

For joining the busbars 60a, 60b, 60c to the contact housing 54, the latter has three grooves or gaps 72 into which the busbars 60a, 60b, 60c are inserted in a form-fitting and/or frictionally engaged manner. In addition or alternatively, it is possible, for example, that the busbars 60a, 60b, 60c are glued into the grooves 72 in an integrally bonded manner by means of an adhesive.

In this embodiment, the bar ends 62a, 62b, 62c each have an approximately hook-shaped or arcuate bar extension 74a, 74b, 74c. As can be seen comparatively clearly in particular on the basis of the sectional view of FIG. 9, the bar extensions 74a, 74b, 74c are each in electrically conductive contact with the corresponding associated contact lug 58′, wherein in FIG. 9 only the phase connector 56 connected to the busbar 60a is shown as an example.

In this exemplary embodiment, the contact lug 58′ is designed in a flexurally elastic manner as a spring hook or spring lug or spring leg of the phase connector 56, to which the bar ends 62a, 62b, 62c are resiliently or floatingly contacted.

In FIG. 10, a third exemplary embodiment of the contact device 52 is shown. As in the exemplary embodiment described above, the bus bars 60a, 60b, 60c are inserted into grooves 72 of the contact housing 54, wherein the side walls of the grooves 72 in this case each have at least one joining extension pair 76. In particular, the grooves 72 of the busbars 60a and 60c each have one joining extension pair 76 and the groove 72 of the busbar 60b has two joining extension pairs 76.

The joining extensions pairs 76 have two axially directed extensions which, after insertion of the busbars 60a, 60b, 60c into the grooves 72, are deformed or re-shaped in such a way that the busbars 60a, 60b, 60c are held in a form-fitting and/or frictionally engaged manner in the grooves 72. The joining extension pairs 76 are formed in this case, in particular, by means of caulking.

The claimed invention is not limited to the exemplary embodiments described above. Rather, other variants of the invention can also be derived therefrom by a person skilled in the art within the scope of the disclosed claims, without departing from the subject matter of the claimed invention. In particular, all individual features described in conjunction with the various exemplary embodiments can also be combined in other ways within the scope of the disclosed claims, without departing from the subject matter of the claimed invention.

### LIST OF REFERENCE SIGNS

2 electric motor
4 motor housing
6 end shield
8 motor shaft
10 bearing seat
11 rolling bearing
12 bearing seat
13 rolling bearing
14 feed-through opening
16 connection socket
18 stator
20 magnetic encoder
22 rotor
24 permanent magnet
26 stator tooth
28 stator winding
30 coil
32 connection element
34 annular body
36 coil former
38 termination
40 insert pocket
42 insert slot
44 slot
46 contact element
48 insulation displacement contact
50 contact slot
52 contact device
54 contact housing
56 phase connector
58, 58′ contact lug
60a, 60b, 60c busbar
62a, 62b, 62c bar end
64a, 64b, 64c bar end
66 recess
68 conductor
70 support surface
72 groove
74a, 74b, 74c bar extension
76 joining extension pair
A axial direction

1-10. (canceled)

11. A stator of an electric motor, the stator comprising:
a plurality of stator teeth each carrying coils of a multi-phase stator winding;
an interconnection element having a plurality of insert pockets with contact elements inserted therein, each with at least one insulation displacement contact forming an interconnection point for a wire portion of coils connected to one another;
a contact device mounted, at least in part, on said interconnection element, and having a contact housing with a connection socket having a number of phase connectors corresponding to a number of phases;
said contact device having a number of busbars corresponding to the number of phases, and each of said busbars having a first bar end and a second bar end;
said first bar ends being flexibly or movably in contact with one each of said phase connectors; and
said second bar ends being inserted or insertable into a respective one of said contact slots of one of said contact elements with clamping contact.

12. The stator according to claim 11, wherein said contact housing is formed with a plurality of radially directed recesses on an outer circumference thereof, each of recesses exposing one of said second bar ends.

13. The stator according to claim 11, wherein each of said first bar ends is contacted with a flexible conductor at said phase connectors.

14. The stator according to claim 11, wherein each of said phase connectors has a flexurally elastic contact lug against which said first bar ends bear resiliently.

15. The stator according to claim 11, wherein said busbars are overmolded as insert parts by said contact housing.

16. The stator according to claim 11, wherein said busbars are joined in grooves of said contact housing.

17. The stator according to claim 11, wherein said contact housing has, on an underside facing said interconnection element, a plurality of axially projecting support surfaces for axial support of said contact device on said interconnection element.

18. The stator according to claim 11, wherein said insulation displacement contact of said contact element includes a first insulation displacement contact and a second insulation displacement contact spaced apart from said first insulation displacement contact.

19. An electric motor, comprising:
a pot-shaped motor housing having an end face;
an end shield closing said end face; and
a stator according to claim 11 inserted in said motor housing.

20. The electric motor according to claim 19, configured as a motor for an anti-lock braking system of a motor vehicle.

21. A contact device for a stator with a plurality of stator teeth carrying phase-selectively connected coils of a multi-phase stator winding, and with an interconnection element having a plurality of insert pockets with contact elements inserted therein, each with at least one insulation displacement contact forming an interconnection point for a wire portion of coils connected to one another, the contact device comprising:
a contact housing with a connection socket having a number of phase connectors corresponding to a number of phases, said contact housing being configured to be fitted, or being fitted, on the interconnection element;
a number of busbars corresponding to the number of phases, each of said busbar having first bar end and a second bar ends;
said first bar ends being flexibly or movably in contact with a respective one of said phase connectors; and
said second bar ends being configured for insertion, or being inserted, into a respective contact slot of the contact elements with clamping contact.
